(19) United States
(12) Patent Application Publication
(10) Pub. No.: US 2005/0099021 A1
(43) Pub. Date: May 12, 2005

(54) Holding structure for trunk lid opening lever

(75) Inventors: Hidenori Jinzu, Aichi (JP); Kotaro Naganawa, Plymouth, MI (US); Joseph Mercadante, Ypsilanti, MI (US)

Correspondence Address: BIRCH STEWART KOLASCH & BIRCH, PO BOX 747, FALLS CHURCH, VA, 22040-0747, US

(73) Assignees: Mitsubishi Jidosha Kogyo Kabushiki Kaisha, Tokyo (JP); Hayashi Telempu., Ltd., Nagayo-Shi (JP)

(21) Appl. No.: 10/926,314

(22) Filed: Aug. 26, 2004

(30) Foreign Application Priority Data
Aug. 28, 2003 (JP) P2003-305218

(51) Int. Cl. E05C 3/06

(52) U.S. Cl. 292/336.3

(57) ABSTRACT

The invention relates to a holding structure for a trunk lid opening lever which is so configured that the trunk lid can be opened from an inside of a trunk room of an automobile, enabling the lever to be easily and reliably operated for improvement of safety. There is proposed a holding structure for a trunk lid opening lever which is provided in a trunk room and connected to a latch mechanism of the trunk room so as to release the latch mechanism, wherein a holding portion for holding a lever is provided in the trunk room, and the holding portion is formed into a shape of cut-out which opens in at least two directions for permitting the lever to be operated in a plurality of operating directions.

### CROSS REFERENCES TO RELATED APPLICATION

This non-provisional application incorporates by reference the subject matter of Application No. 2003-305218 filed in Japan on Aug. 28, 2003, on which a priority claim is based under 35 U.S.C. § 119(a).

### BACKGROUND OF THE INVENTION

1. Field of the Invention

The present invention relates to a holding structure for a trunk lid opening door in which the trunk lid can be opened from an inside of a trunk room of an automobile.

2. Description of the Related Art

Conventionally, there has been generally known such an art that even in a case where a child or the like has been trapped inside a trunk room of an automobile by mistake, the child or the like can open a trunk lid by releasing a latch mechanism of the trunk lid.

As an example of the art, the trunk room is provided therein with a lever 101 connected to a latch mechanism (not shown) of a trunk lid by way of a wire 103, as shown in FIG. 9, and constructed in such a manner that the lever 101 can be operated to release the latch mechanism. In the example shown in FIG. 9, a base portion 102 of the lever 101 is engaged and held by an engaging portion (a hole) 111 which is formed in an interior member 110 in the trunk room, and the lever 101 has an arrow mark (See numeral 104) showing an operating direction which is painted with light storing paint (or fluorescent paint) so that the operating direction can be recognized even in the dark.

In a case where a man such as a child has been trapped in the trunk room, the trunk lid can be opened from the inside of the trunk room by pulling the lever 101 to release the latch mechanism in the operating direction as shown in FIG. 9 (in a direction of the arrow mark 104).

However, the lever 101 is held by the engaging portion 111 of the interior member 110, and the operating direction of the lever 101 is only one, that is, the direction of the arrow mark in FIG. 9. For this reason, unless the lever 101 is pulled only in this direction, the man will be unable to release the latch mechanism to open the trunk lid.

JP-A-2001-207707 discloses an art of releasing the latch mechanism to open the trunk lid, by rotating a handle provided in the trunk room, instead of the above-described lever.

However, even with this art, the trunk lid will not be opened, unless the handle is operated only in a specified direction.

### SUMMARY OF THE INVENTION

An object of the present invention is to provide a holding structure for a trunk lid opening lever, which enables the lever to be operated easily, and reliably for improvement of safety.

For this purpose, according to the invention, a holding portion for holding the lever is provided in the trunk room and an opening portion is provided on the holding portion and formed into a shape of cutout which opens in at least two directions for permitting the lever to be operated in a plurality of operating directions. With this structure, the trunk lid opening lever can be easily and reliably operated, and a man can easily open the trunk lid when he has been trapped in the trunk room.

In another aspect of the invention, a holding portion for holding the lever is provided in the trunk room, the lever has an operating portion at its one end to be operated by a man and a base portion at the other end to be held by the holding portion, and the lever is held in a manner that the operating portion can be rotated around the other end of the lever. Therefore, the man who has been trapped in the trunk room can pull the lever without caring about the operating direction of the lever, and the trunk lid can be opened favorably.

### BRIEF DESCRIPTION OF THE DRAWING

These and other objects and advantages of this invention will become more fully apparent from the following detailed description taken with the accompanying drawings in which:

FIG. 1 is a schematic view showing a general structure of an embodiment according to the invention;

FIG. 2 is a plan view schematically showing the general structure of the embodiment according to the invention;

FIG. 3 is a perspective view schematically showing a lever holding portion of the invention;

FIG. 4 is a sectional view taken along a line a-a in FIG. 3;

FIG. 5 is a sectional view taken along a line b-b in FIG. 3;

FIG. 6 is a sectional view taken along a line c-c in FIG. 3;

FIG. 7 is a perspective view schematically showing an example of modification of the invention;

FIG. 8 is a sectional view schematically showing another example of modification of the invention; and

FIG. 9 is a schematic view showing an example of a related art.

### DETAILED DESCRIPTION OF THE PREFERRED EMBODIMENTS

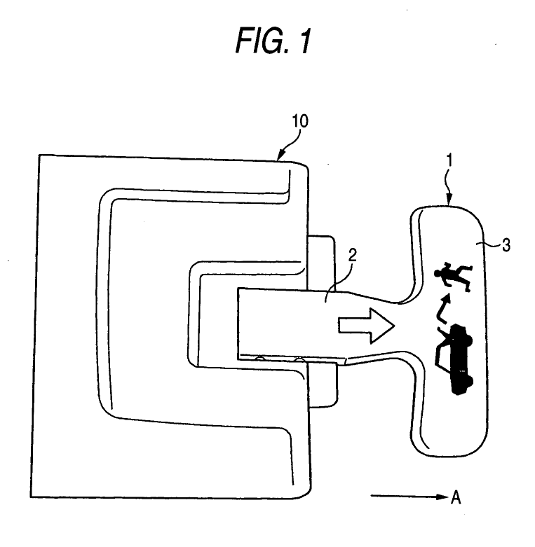

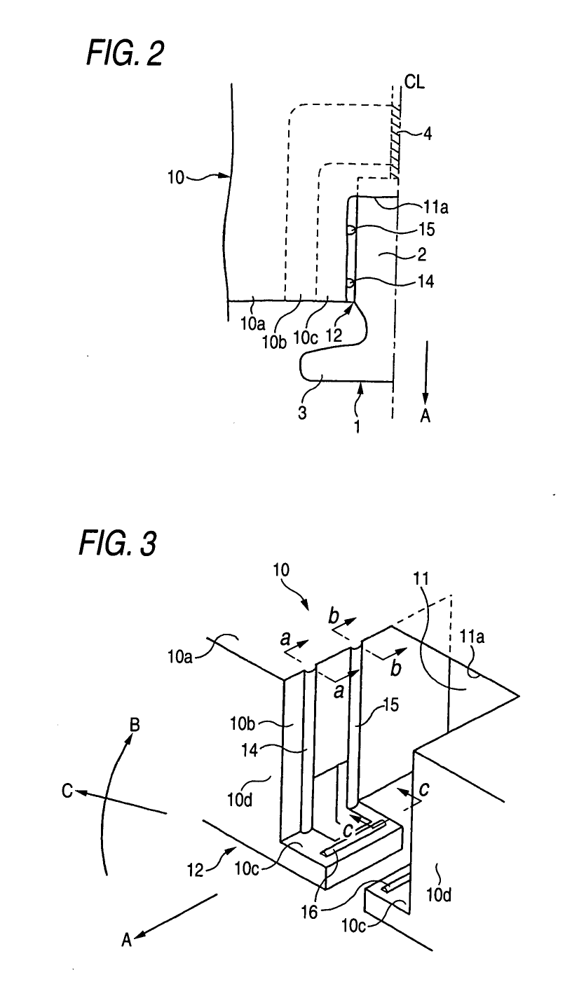

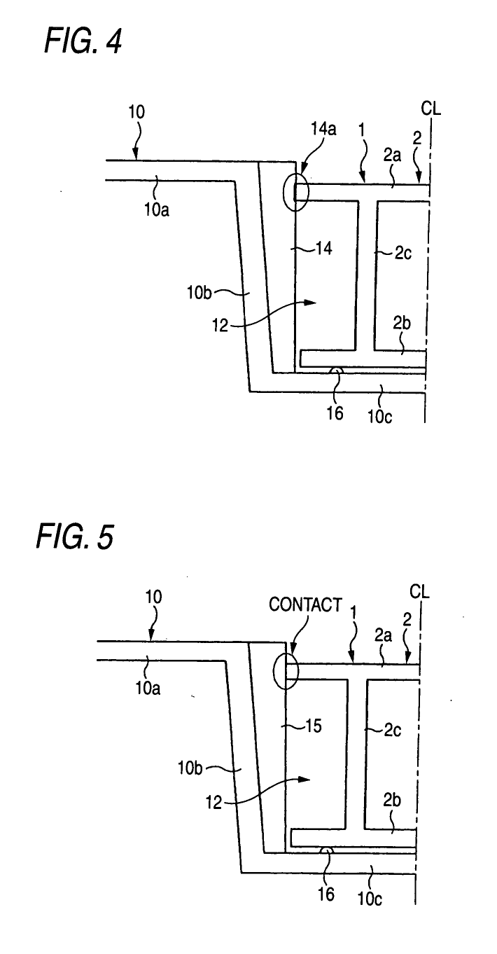

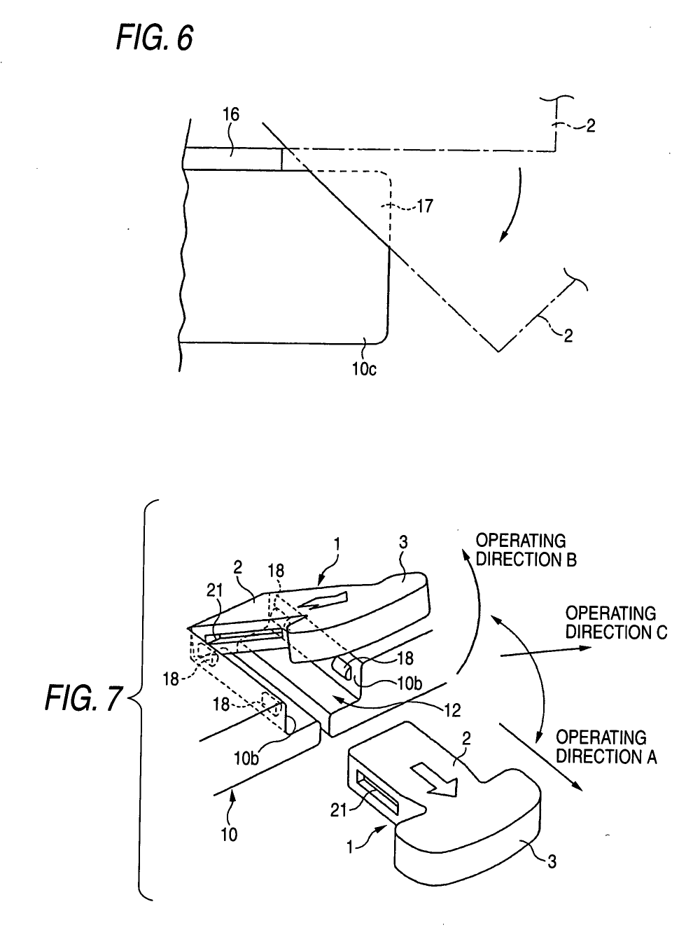

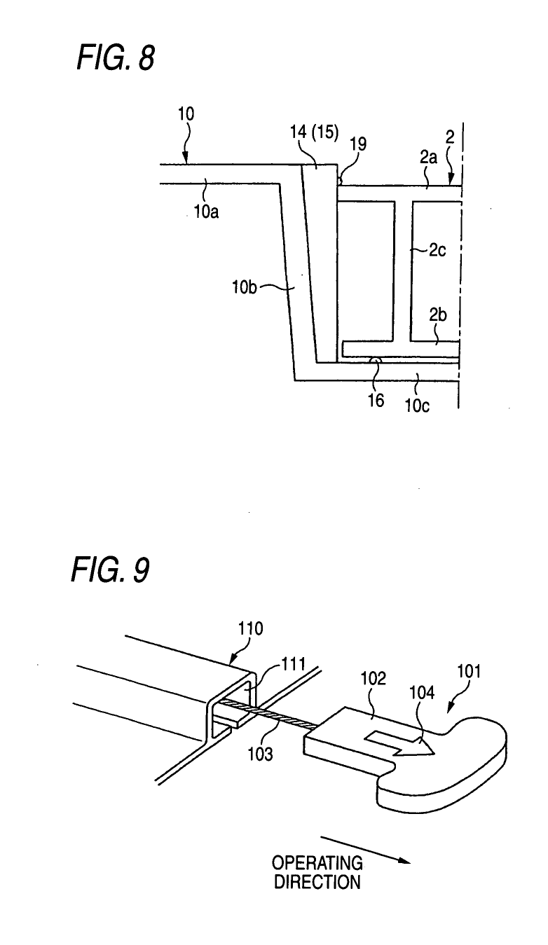

Now, referring to drawings, a holding structure for a trunk lid opening lever according to an embodiment of the invention will be described. FIG. 1 is a schematic view showing a general structure. FIG. 2 is a plan view of the general structure. FIG. 3 is a perspective view schematically showing a lever holding portion of the same. FIG. 4 is a sectional view taken along a line a-a in FIG. 3. FIG. 5 is a sectional view taken along a line b-b in FIG. 3. FIG. 6 is a sectional view taken along a line c-c in FIG. 3.

In FIG. 1, numeral 1 is a lever for opening a trunk lid including a base portion 2 and a grip portion 3. The lever 1 is disposed in a trunk room, and connected to a latch mechanism (not shown) by way of a wire 4 (See FIG. 2). An explanation of the latch mechanism and a mechanism for releasing the latch mechanism is omitted in the embodiment, because they are generally known. Moreover, the lever 1 has an arrow mark as shown in FIG. 1 or other signs schematically showing functions of the lever, which are painted with fluorescent paint or the like.

Under normal conditions, the lever 1 is held and stored by a holder 10 that is made of resin and disposed in the trunk room. The wire 4 is connected to the base portion 2 along a direction of a centerline CL in FIG. 2, and configured to release the latch mechanism by operating the lever 1 essentially in a direction of disposing the wire 4 (that is, a direction of an arrow mark A in FIGS. 1 to 3).

Moreover, according to the invention, various contrivances have been made so that the lever 1 can be operated in a plurality of operating directions, besides the above described direction of the arrow mark A. Describing hereinafter specifically, a holding portion 12 capable of storing and holding the lever 1, as shown in FIGS. 2 and 3, is formed on the holder 10, and the base portion 2 of the lever 1 is configured to be engaged with the holding portion 12 to be held therein.

The holding portion 12 is formed into such a shape that an upper face 10a and a front face 10d of the holder 10 are cut away. In the manner, the holding portion 12 has openings in two directions, namely in a direction of the upper face 10a and in a direction of the front face 10d. For reference, the upper face 10a of the holder 10 is on a plane substantially parallel to a direction of disposing the wire 4, while the front face 10d of the holder 10 is on a plane substantially perpendicular to the direction of disposing the wire 4.

Since the holding portion 12 is so configured that the openings are formed in the two directions, as described above, on occasion of operating the lever 1, it is possible to operate the lever 1 not only in the direction of the arrow mark A as shown in FIG. 3, but also in a direction of upward rotation as shown by an arrow mark B in FIG. 3 and in a diagonal direction as shown by an arrow mark C in FIG. 3.

In other words, on occasion of operating the lever 1, the latch mechanism can be released by conducting at least one of the following operations.
1. Pull the lever 1 straightly in the direction A.
2. Rotate the lever 1 in the direction B in a manner of erecting the lever.
3. Pull the lever 1 in a diagonal direction (the direction C) at an appropriate angle.

In the manner, the lever 1 can be operated reliably and easily, so that the trunk lid can be opened. The direction as shown by the arrow mark C in FIG. 3 may be at any desired angle between 0 to substantially 90 degree, but need not be limited to a determined angle.

By the way, the base portion 2 of the lever 1 is integrally formed with an upper face portion 2a, a lower face portion 2b and a vertical wall portion 2c connecting the upper face portion 2a and the lower face portion 2b. The upper face portion 2a is formed larger in width than the lower face portion 2b.

On the other hand, side wall faces 10b of the holding portion 12 are respectively formed with a first rib 14 and a second rib 15 so as to clamp the base portion 2 of the lever 1 from both sides for retaining the base portion 2. These ribs 14, 15 are integrally formed with the holder 10 by injection molding, for example.

As shown in FIG. 4, the first rib 14 formed on a front side includes an overlapping portion 14a that slightly interferes with the base portion 2 of the lever 1 when the lever 1 is stored in the holding portion 12. By providing the overlapping portion 14a, the first rib 14 presses an edge of the upper face portion 2a of the base portion 2 while the lever 1 is stored, so that the base portion 2 can be retained by friction between the first rib 14 and the upper face portion 2a of the base portion 2.

The second rib 15 is formed in parallel to the first rib 14, into a size that the second rib 15 comes into contact with the upper face portion 2a of the base portion 2, hardly interfering with the upper face portion 2a. Accordingly, when the lever 1 is stored, the second rib 15 is brought into contact with the base portion 2, in such a manner that almost no friction is occurred between the second rib 15 and the upper face portion 2a. In the embodiment, the second rib 15 is provided for the purpose of restricting a position of the base portion 2 of the lever 1 in a lateral direction (a left to right direction in FIG. 5). By providing the second rib 15 in the manner, a backlash of the lever 1 on occasion of storing it can be prevented without requiring a large control force.

Further, as shown in FIGS. 4 and 5, the first rib 14 and the second rib 15 are respectively spaced from the vertical wall portion 2c. More specifically, the ribs 14, 15 and the vertical wall portion 2c are so configured that spaces are maintained between them. This is because, in a case where the vertical wall portion 2c is kept in contact with these ribs 14, 15, contact areas of the ribs 14, 15 with respect to the lever 1 will be too large, and a larger friction than suitable for the operation of the lever 1 (retaining force or engaging force of the lever 1) will be occurred, which leads to an inconvenience that the lever 1 can not be pulled out.

By contrast, in the embodiment, the ribs 14, 15 are kept in contact with only the upper face portion 2a of the base portion 2 of the lever 1, and so, after the upper face portion 2a has moved away from the ribs 14, 15 on occasion of operating the lever 1, the lever 1 will be in such a free state that the friction will not occurred. In the manner, the lever 1 can be easily operated even with a little force. Moreover, because the contact areas between the ribs 14, 15 and the upper face portion 2a are minimized, the friction can be easily set.

In addition, as shown in FIGS. 3 to 6 respectively, a bottom face 10c of the holding portion 12 is also provided with a rib (ribs on bottom face side) 16 along a direction of disposing the base portion 2. Since the lever 1 is disposed on the rib 16, the lever 1 is lifted by a height of the rib 16 and held in the holding portion 12. Moreover, as shown in FIG. 6, an upper face side of a backward end of the bottom face 10c is so-called chamfered (See reference numeral 17).

Since the rib 16 are provided on the bottom face 10c, and the upper face side of the backward end of the bottom face 10c are chamfered (17) in the manner, when the man trapped in the trunk room pulls up the lever 1 (See the arrow mark B in FIG. 3) or pulls it diagonally upwardly (See the arrow mark C in FIG. 3), he will be able to pull up the lever 1 smoothly, without a trouble that the base portion 2 of the lever 1 may be caught by the backward end of the bottom face 10, as shown by a phantom line in FIG. 6.

Still further, as shown in FIG. 3, another opening 11 is formed in a deeper position than the holding portion 12 of the holder 10. An end of the base portion 2 (an opposite end to the grip portion 3) is inserted into th opening 11 as shown in FIG. 2, and when the lever 1 is operated, the lever 1 can be easily rotated around an upper edge 11a (See FIGS. 2 and 3) of the opening 11 as a fulcrum.

According to the above-described structure, the following actions and effects can be obtained.

The lever 1 has the arrow mark showing the essential operating direction or the sings schematically showing its function which are painted with the fluorescent paint or the like. Therefore, even in a case where the man has been trapped in the trunk room by mistake, and surroundings are pitch-dark, the lever 1 can be easily found out.

Moreover, openings are formed in the two directions, namely, in both the directions of the upper face 10a and the front face 10d of the holding portion 12 for holding the lever 1. Since the lever 1 is configured to be operated in a plurality of the operating directions (See the arrow marks A to C in FIG. 3), the lever 1 can be easily operated. As the results, the man trapped in the trunk room can easily open the trunk lid by operating the lever 1 in either direction, and can escape from the trunk room. In the manner, safety of the man trapped in the trunk room can be enhanced more than before.

Further, due to presence of the two ribs 14, 15 formed in the holding portion 12, the lever 1 can be reliably retained in the holding portion 12 of the holder 10 under the condition that the lever 1 is not used, and the lever 1 can be prevented from dropping or the like.

Specifically, the first rib 14 is provided with the overlapping portion 14a, which slightly interferes with the base portion 2 of the lever 1 while the lever 1 is stored, and therefore, the lever 1 can be reliably retained by the friction between the first rib 14 and the lever 1. On the other hand, because the second rib 15 is formed so as to come into contact with the lever 1, the position of the lever 1 is restricted by the second rib 15 when the lever 1 is stored, and a so-called backlash of the lever 1, on occasion of storing the lever 1, can be prevented.

Still further, when the lever 1 is rotated, the lever 1 can be easily rotated by making the edge 11a of the opening 11 to be the fulcrum. Additionally, by providing the rib 16 on the bottom face 10c of the holding portion 12, and chamfering (17) the upper face side of the backward end of the bottom face 10c, the lever 1 can be smoothly pulled up.

Then, referring to FIG. 7, an example of modification of the invention will be described. In the following description, different portions from the above-described embodiment will be mainly described, and those portions configured in the same manner as in the above-described embodiment will be omitted from the description.

In the modified example, the side wall faces 10b of the holding portion 12 are respectively provided with projections 18 which are projected toward the base portion 2 of the lever 1 stored in the holding portion 12. On the other hand, the base portion 2 is formed with recess portions 21 on its side faces respectively at positions corresponding to the projections 18 which can contain the projections 18. These projections 18 are appropriately set having a height and shape that the lever 1 can be relatively easily stored on occasion of storing the lever 1.

When the lever 1 is stored, the projections 18 are contained in the recess portions 21 of the base portion 2 to hold the lever 1 in the holding portion 2 of the holder 10.

In other words, whereas the above described embodiment is so configured that the lever 1 is retained by the friction between the rib 14 and the base portion 2 of the lever 1, the modified example is so configured that the lever 1 is retained by an engagement between the recess portions 21 of the base portion 2 and the projections 18. In the respect, the modified example is different from the above-described embodiment. Although the opening and the ribs on the bottom face side (See numerals 11 and 16 in FIG. 3) described in the above described embodiment are not provided in the modified example, the opening and the ribs on the bottom face side may be provided in the same manner as in the above described embodiment. It is also suitable to chamfer (See numeral 17) the backward end of the bottom face 10c, in the same manner as in the above-described embodiment.

As described herein above, the modified example of the invention can also obtain the same actions and effects as the above described embodiment. In addition, it is advantageous that a cost can be decreased in the modified example, because the friction need not be set, and high dimensional precision is not required for the projections 18.

The invention is not limited to the above-described embodiment and the modified example, but various modifications can be made within a scope not deviating from a gist of the invention. For example, both or either one of the ribs 14, 15 may be provided, in an upper area thereof, with a protrusion 19 which is configured to be engaged with the edge of the upper face portion 2a of the base portion 2 of the lever 1. In a case where such a protrusion is provided, the first rib 14 need not be provided with the overlapping portion (numeral 14a in FIG. 4). The similar actions and effects as in the above-described embodiment can be also obtained in the case where the protrusion 19 is provided.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A holding structure for a trunk lid opening lever provided in a trunk room and connected to a latch mechanism so as to release the latch mechanism, comprising:
a holding portion that holds the lever provided in the trunk room; and
an opening portion provided on the holding portion and formed into a shape of cutout which opens in at least two directions for permitting the lever to be operated in a plurality of operating directions.

2. The holding structure for the trunk lid opening lever according to claim 1, wherein
the lever has a base portion to be held in the holding portion and an operating portion to be operated by a man, and
the holding portion is provided with a rib projected toward the base portion of the lever.

3. The holding structure for the trunk lid opening lever according to claim 2, wherein the rib includes
a first rib that presses the base portion so as to retain the lever by friction between the rib and the base portion, and
a second rib that comes into contact with the base portion to restrict a position of the base portion.

4. The holding structure for the trunk lid opening lever according to claim 1, wherein
the holding portion is provided with a projection projected toward the base portion of the lever, and
the base portion is formed with a recess portion at a position corresponding to the projection in which the projection is held.

5. A holding structure for a trunk lid opening lever which is provided in a trunk room and connected to a latch mechanism so as to release the latch mechanism, comprising:
a holding portion that holds the lever provided in the trunk room, wherein
the lever has an operating portion at its one end to be operated by a man and a base portion at the other end to be held by the holding portion, and
the lever is held in a manner that the operating portion can be rotated around the other end of the lever.
